(19) United States
(12) Patent Application Publication
(10) Pub. No.: US 2003/0212913 A1
(43) Pub. Date: Nov. 13, 2003

(54) System and method for detecting a potentially malicious executable file

(76) Inventor: David Vella, Siggiewi (MT)

Correspondence Address: WILDMAN, HARROLD, ALLEN & DIXON, 225 WEST WACKER DRIVE, CHICAGO, IL, 60606, US

(21) Appl. No.: 10/429,380

(22) Filed: May 5, 2003

(30) Foreign Application Priority Data
May 8, 2002 (GB) 0210522.9

(51) Int. Cl. H04L 9/00

(52) U.S. Cl. 713/202

(57) ABSTRACT

A system and method for detecting a potentially malicious executable file is described. An executable file, for example attached to an electronic mail message or downloaded to a computer system, is trapped and disassembled to provide an analysable file. The analysable file is analysed to determine whether any program call is made by the executable file and whether any detected program call is potentially malicious by comparing the program call with a list of known potentially malicious program calls. If the program call is potentially malicious, the executable file is quarantined or deleted.

### BACKGROUND OF THE INVENTION

1) Field of the Invention

This invention relates to detecting a potentially malicious executable file.

2) Description of the Related Art

Known anti-virus systems and methods are able to detect known viruses in known executable files, but are unable to do so for unknown executable files. This has led to many users such as companies blocking the entry of all executable files indiscriminately at firewall, electronic mail server and electronic mail client level. This may be done, for example, by blocking all files which have any of the commonly used subscripts for executable files, for example .exe, .com, .vbs, .lnk, .pif, .scr and .bat. However, this approach severely limits productivity of a company's employees, because received executable files may contain applications or data that are needed for the employees to do their daily work.

### SUMMARY OF THE INVENTION

The present invention seeks at least to a meliorate the above-stated limitation of known anti-virus & other security systems.

According to a first aspect of the present invention there is provided a system for detecting a potentially malicious executable file, the system comprising: trapping means for trapping an executable file and disassembling the executable file to provide an analysable file; analysing means in communication with the trapping means for analysing the analysable file to determine whether a program call is made by the executable file and whether the program call is potentially malicious; a database of potentially malicious program calls and details of the functions of the program calls and quarantining means in communication with the analysing means for quarantining the executable file, with details retrieved from the database of the function of the program call made by the potentially malicious executable file, if the program call is potentially malicious, for determination whether the potentially malicious executable file should be released from quarantine or deleted.

Conveniently, the trapping means is adapted to trap an electronic mail message.

Preferably, the trapping means includes parsing means for parsing the message to determine whether the message has an attachment.

Conveniently, the trapping means is adapted to receive a file to be downloaded to a computer system which file is trapped by at least one of a firewall and a proxy server.

Preferably, the trapping means includes parsing means for parsing the downloaded file to determine whether the file is executable.

Preferably, the analysing means is adapted for detecting a program call command.

Conveniently, the analysing means is adapted for detecting a program making a system call.

Advantageously, the analysing means is adapted for detecting a call to a dependent program.

Advantageously, the analysing means is adapted for detecting a call to application extension code.

Advantageously, the analysing means is adapted for detecting a call to at least one of dynamic link library (DLL) executable code and a COM object.

Preferably, the analysing means includes identification means for identifying the dynamic link library or COM object called and comparison means for comparing the identified dynamic link library executable code or COM object with a list of dynamic link library code or COM objects which are known to be potentially malicious.

Advantageously, the analysing means includes means for determining whether there is a plurality of calls to dependent programs.

Preferably, the analysing means includes a database of characteristics of known potentially malicious dynamic link libraries and/or COM objects and means for interrogating the database for the characteristics of a data link library and/or COM object to which a program call is made by the executable program.

Conveniently, the quarantine means includes reporting means for providing, to an administrator, information on the executable file for the administrator to decide whether the executable file should be passed to an intended recipient or deleted.

Conveniently, the quarantine means includes means for deleting the potentially malicious executable file.

Advantageously, the quarantine means includes reporting means for informing at least one of a sender of the potentially malicious executable file and an intended recipient of the file that the file has been quarantined or deleted.

According to a second aspect of the invention, there is provided a method for detecting a potentially malicious executable file, the method comprising the steps of:

a) trapping an executable file;

b) disassembling the executable file to provide an analysable file;

c) analysing the analysable file to determine whether a program call is made by the executable file;

d) determining whether the program call is potentially malicious;

e) providing a database of potentially malicious program calls and their functions;

f) if the program call is potentially malicious, quarantining the executable file with the function of the potentially malicious program call retrieved from the database; and

g) determining at least partially from the function of the potentially malicious program call whether to delete or release from quarantine the potentially malicious executable file.

Conveniently, the step of trapping the executable file comprises trapping an electronic mail message.

Preferably, the step of trapping the electronic mail message includes the step of parsing the message to determine whether the message has an attachment and trapping the message if the message has an attachment.

Conveniently, the step of trapping an executable file includes receiving a file to be downloaded to a computer system which file has been trapped by at least one of a firewall and a proxy server.

Preferably, the step of trapping the executable file includes parsing the file to be downloaded to determine whether the file is executable, and trapping the file if executable.

Conveniently, the step of analysing the analysable file includes a step for detecting a program call command.

Conveniently, the step of analysing the analysable file includes a step for detecting a program making a system call.

Conveniently, the step of analysing the analysable file includes a step for detecting a call to a dependent program.

Advantageously, the step of analysing the analysable file includes a step for detecting a call to application extension code.

Advantageously, the step of analysing the analysable file includes a step for detecting a call to at least one of dynamic link library (DLL) executable code and a COM object.

Advantageously, the step for detecting a call to dynamic link library executable code or a COM object includes identifying the dynamic link library or COM object called and the step of determining whether the system call is potentially malicious includes comparing the identified dynamic link library executable code or COM object with a list of dynamic link library code or COM objects to which calls are known to be potentially malicious.

Advantageously, the step of determining whether the system call is potentially malicious includes determining whether there is a plurality of calls to dependent programs.

Preferably, the step of determining whether a system call is potentially malicious includes providing a database of characteristics of known potentially malicious data link libraries and/or COM objects and interrogating the database for the characteristics of a dynamic link library and/or COM object to which a program call is made by the executable program.

Conveniently, the step of quarantining the executable file includes providing, to an administrator, information on the executable file for the administrator to decide whether the executable file should be passed to an intended recipient or deleted.

Preferably, providing information on the executable file includes providing the characteristics of a data link library and/or COM object to which a system call is made by the executable program.

Conveniently, the step of quarantining the executable file comprises a step for deleting the executable file.

Advantageously, the step of quarantining the executable file includes informing at least one of a sender of the file and an intended recipient of the file that the file has been quarantined or deleted.

### BRIEF DESCRIPTION OF THE DRAWINGS

The invention will now be described, by way of example, with reference to the accompanying drawings in which:

FIG. 1 shows a schematic diagram of the system according to the invention;

FIG. 2 is a flow chart of a first embodiment of the invention;

FIG. 3 is a flow chart of a detail of the embodiments of FIGS. 2 and 6;

FIG. 4 is an example of disassembled executable code helpful in understanding the invention

FIG. 5 is a further example of disassembled executable code helpful in understanding the invention;

FIG. 6 is a flowchart of a second embodiment of the invention; and

FIG. 7 is a flowchart of quarantining procedures used in the invention.

### DESCRIPTION OF THE PREFERRED EMBODIMENT

In the figures like reference numerals represent like parts or steps.

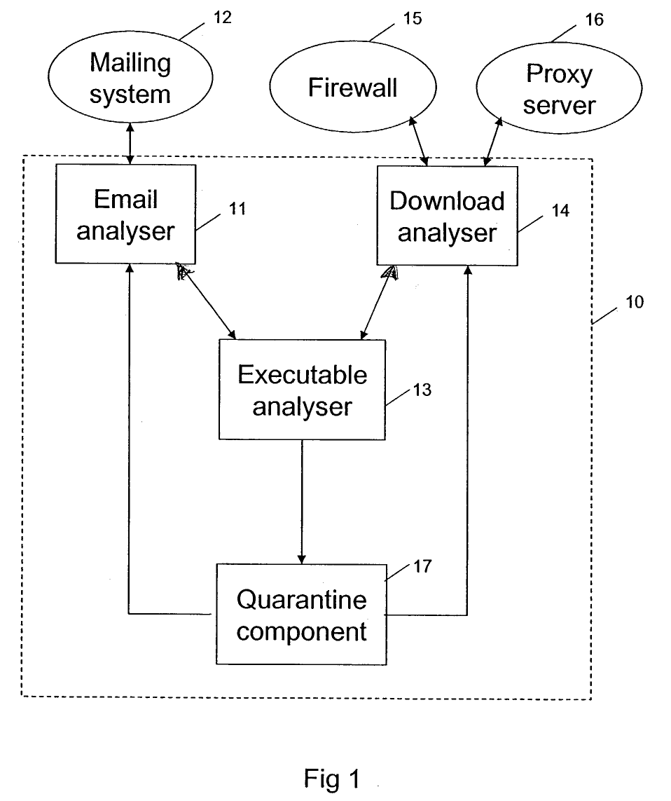

Referring to FIG. 1, the system 10 of the invention includes an electronic mail analyser 11 for interfacing with an external mailing system 12, such as Microsoft Exchange Server™, Lotus Notes™, or a SMTP/POP3 server, to capture all incoming and outgoing mail passing through the mailing system and analyse whether an electronic mail message has any executable attachments. The electronic mail analyser 11 is connected to an executable file analyser 13 so that when the electronic mail analyser 11 determines that a message does have an executable attachment the electronic mail analyser 11 passes the message, or at least the executable attachment, to the executable file analyser 13 where the message or attachment is queued for processing by the executable file analyzer 13.

Similarly, there is provided a download analyser 14 for interfacing with a firewall 15 such as Checkpoint Firewall™ or a proxy server 16 such as Microsoft™ ISA Server to capture all downloads made by users and check whether any of the downloads include executable files. The download analyser 14 is also connected to the executable analyser 13 so that if the download analyser 14 determines that the download does include an executable file, the download analyser 11 passes the download file to the executable file analyser 13 where the file is queued for processing by the executable file analyzer 13.

The executable file analyser 13 is connected to a quarantine component 17 so that if the executable analyser determines, in a manner to be described, that the executable file is potentially malicious the file is quarantined. If the executable file is found not to be potentially malicious the message is returned to the email analyser for returning to the mailing system 12 for onward transmission to an intended recipient, or the downloadable file is returned to the download analyser 14 for delivery to a user, respectively.

The invention is applicable to electronic mail messages which are incoming to, or outgoing from, the computer system.

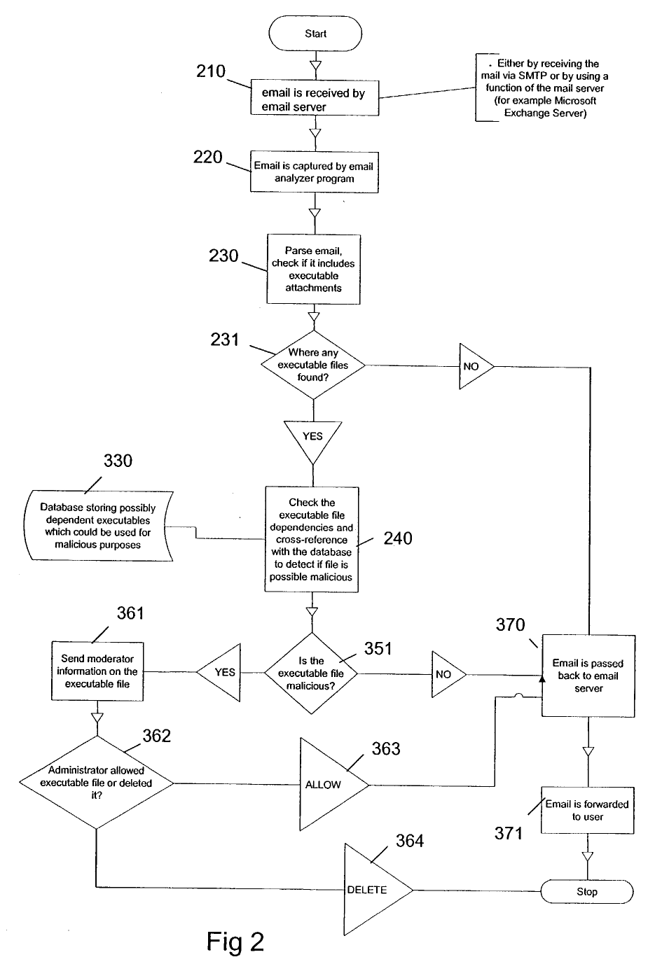

The method of the invention will now be described by reference to FIGS. 2 to 7.

The invention provides a method for detecting whether an executable file is potentially malicious, by profiling program calls or system calls the executable file makes, and cross-referencing the program calls or system calls with a list of known calls/files that can be used maliciously to access a system. Program calls are typically to a dynamic link library (DLL) or COM object. System calls are typically to a DLL or other file that is part of an underlying operating system, for example, Microsoft Windows™. These system calls are documented in an operating system application program interface (API). A dynamic library is a file of code that can be called by other executable code, either an application program or another DLL, but which unlike an executable file cannot be directly run. That is, a DLL must be called from other code that is already executing. DLL files are typically dynamically linked with a program using them during program execution, rather than being compiled with the program.

For example, if it is detected that an executable file uses the known DLL file “winsock.dll”, then the executable file is likely to activate a network function. This is highly suspicious and therefore one could flag the executable as suspicious or potentially malicious. From experience, the probability that an executable file is malicious is known to be increased if the executable file makes systems calls to certain known combinations of DLL files.

Referring first to FIGS. 1 and 2, the invention will be described in relation to detecting a potentially malicious executable file associated with an electronic mail message. An electronic mail message received, step 210, by an electronic mail server or system 12 is captured, step 220, by the electronic mail analyser program 11, i.e. the electronic mail is interrupted before the message can be sent to an intended recipient, irrespective of whether the message is incoming or outgoing, all incoming and outgoing electronic mail being captured. However, it will be understood that in particular applications of the invention only incoming or outgoing mail is captured or only electronic mail from particular senders or from unrecognised senders and/or addressed to particular recipients is captured.

The electronic mail analyser program 11 analyses the electronic mail message by parsing, step 230, the message to determine, step 231, whether the message has any executable attachments. If there are executable attachments, the attachments are passed to the executable analyser program 13.

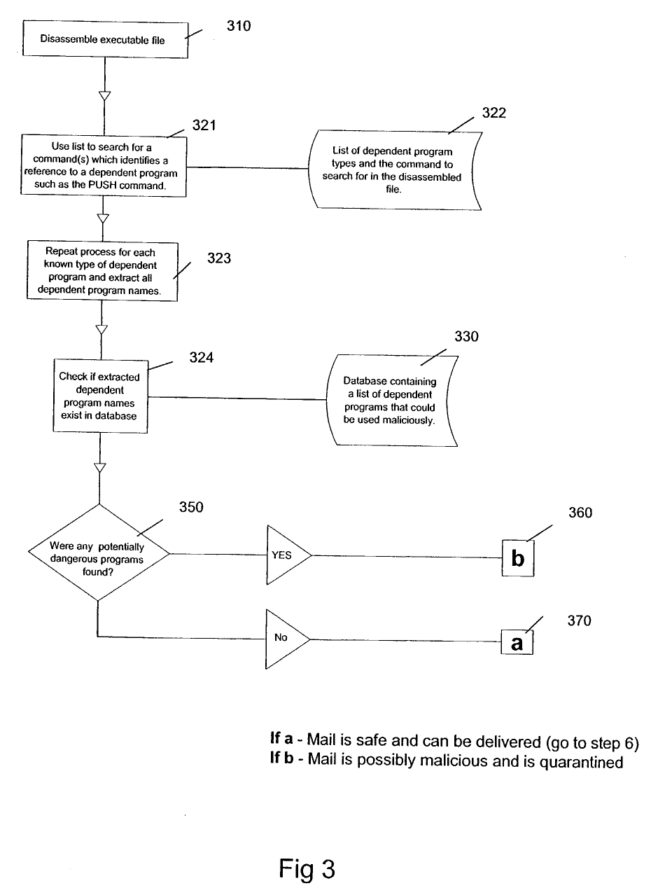

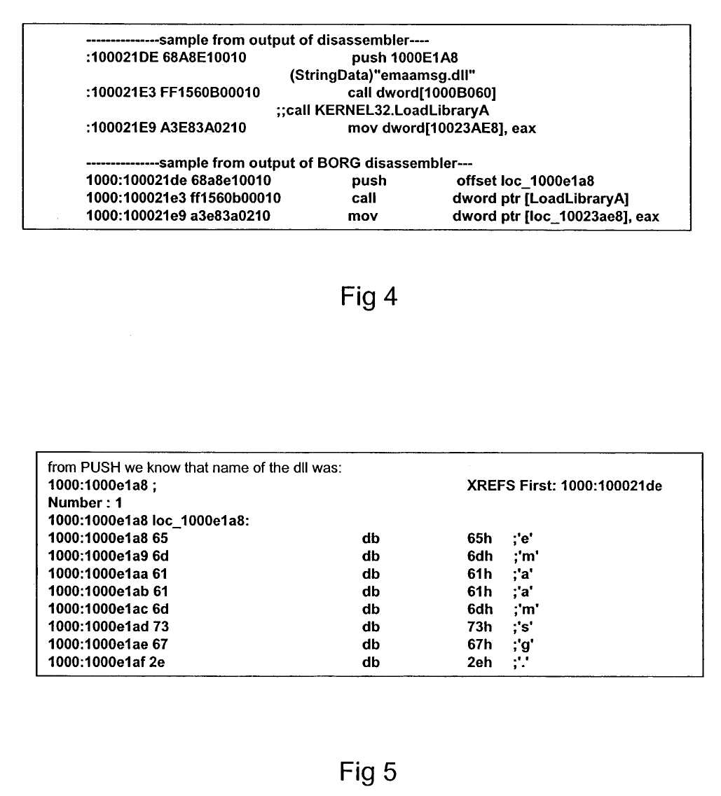

Referring also to FIG. 3, the executable file analyser program 13 disassembles, step 310, the executable file to an analysable file. The analysable file is searched, step 321, for a reference or system call to a dependent file or program. This may be accomplished by, for example, searching for commands, such as a PUSH assembly command. This is accomplished by searching for the first command in a list 322 of commands known to call dependent programs. When a command referencing a dependent file is found, for example a PUSH assembly command, the dependent program/file name, for example “wsock32.dll” is extracted. FIGS. 4 and 5 illustrate examples of output from disassembler programs revealing the presence of a program call to “emaamsg.dll” dynamic link library. FIG. 4 shows a readable assembly, displaying a reference to a dependent file through the PUSH command, to obtain the name of a dynamically loaded DLL. FIG. 5 illustrates a readable assembly showing the name of a DLL. The name of the extracted dependent program code, e.g. “wsock32.dll”, is cross-checked, step 324, against a database 330 of known executable code or dynamic link library (DLL) file names representing known programs that could be used maliciously, and details of the function of the known executable code or DLL are read, from such details previously stored in a database 330. The database 330 contains only the names of DLL files etc. which it is known a priori are potentially malicious, i.e. have possible malicious applications. Within this possibility exists the possibility that some combinations of otherwise potentially harmless DLL files are potentially malicious only when used in combination. Therefore, these combinations of otherwise harmless files also are included in the database. Files which cannot be used maliciously, even in combination, are not included in the database. Therefore, the report to the administrator, discussed below, concerns only potentially malicious files or combinations of files found. This has the advantage of giving the administrator the minimum required information on which to base a decision. The name of the called executable code and the data read from the database may be stored in a dependencies store, for subsequent determination of multiple system calls and for reporting. Alternatively, only the names of the called executable code is stored in the dependencies store, and data is read directly from the database 330 when the dependencies are reported.

The search procedure is continued by searching in the analysable file in turn for each of the commands in the list of commands 322 for further instances of commands known to be potentially malicious, and reading, the characteristics of found known executable code from the database 330 for storing in the dependencies store for later reporting.

As a further example, dependent COM objects may be searched for by searching for calls to a CoCreateInterface or CoCreateInstanceEx. If a call to CoCreateInterface is found the first and fourth push commands from the call are found and the address to a Class Indentifier (CLSID) or Interface Identifier (IID) is extracted and the CLSID or IID used to identify a COM object used by the executable. If a call to CoCreateInstanceEx is found, only the first push command is checked.

A determination of the potential maliciousness of the executable file is also judged by checking for multiple dependencies. For example if an executable file is dependent on ‘wsock32.dll’ (Windows socket 32-bit DLL file) and ‘tapi32.dll’ (Microsoft Windows™ Telephony Client DLL) then most probably the file is a malicious executable file, whereas if the file depends only on ‘wsock32.dll’ the executable file is only possibly malicious.

When searching of the executable file for dependencies is complete, the dependencies store is interrogated, step 350, and if it is determined, that the file does not contain any suspicious or potentially malicious dependencies, the electronic mail message is passed back, step 370, to the electronic mail analyser program for reassembly, and the executable file is re-attached to the message for sending by the mailing system 12 to the intended recipient If, however, it is determined, step 350, that the executable file contains dependencies on potentially malicious executable code, the executable file is quarantined including all the information retrieved from the database 330, such as the name of the DLL found and the most common uses of the DLL. This information is reported, step 361, to an administrator to determine, step 362 (see FIG. 2), whether to allow, step 363, the electronic mail message to be passed, step 370, back to the electronic mail analyser 11 for delivery by the mailing system 12 to an intended recipient or whether to delete, step 364, the executable file with potentially malicious dependencies.

Although the embodiment has been described in relation to electronic mail attachments, it will be understood that the invention has equal applicability to detecting electronic mail messages which are themselves, or contain within the body of the electronic mail message, potentially malicious executable program code.

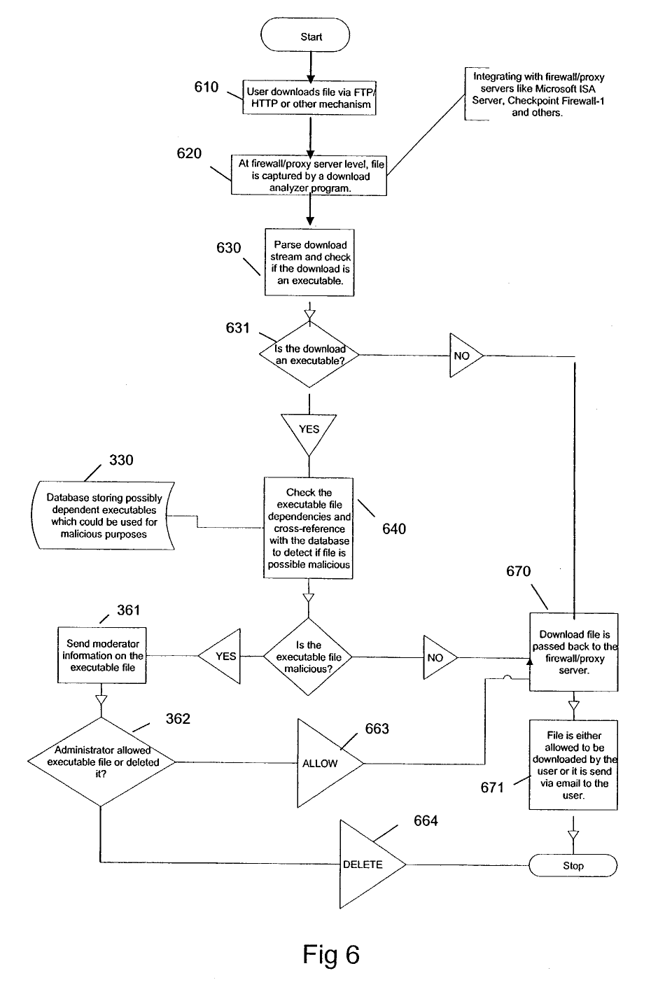

The application of the invention for analysing downloadable files is illustrated in FIG. 6. A user downloads, step 610, a file via FTP/HTTP or another mechanism. At firewall 15 or proxy server 16 level, the downloaded file is captured, step 620, by the download analyser program 14. The download is completed, but the user does not receive the downloaded file. Instead, the user receives a notification that his downloaded file is being analysed. All downloaded files are captured in this manner. The download analyser program 14 analyses the downloaded file by parsing, step 630, the file to determine, step 631, whether the file is executable. If the download includes an executable file, the executable file is passed to the executable analyser program 13 to determine, step 640, whether the file has potentially malicious dependencies. The steps of the determination are as described above, and illustrated in FIG. 3, in relation to electronic mail message attachments. If the file contains dependencies on potentially malicious files, the executable file is again quarantined, step 360, including all the information retrieved from the database 330, such as the DLL name found and what the DLL is most commonly used for. This information is reported, step 361, to an administrator to determine, step 362, whether to allow, step 663, the downloaded file to be passed, step 670, back to the download analyser 14 for delivery 671 through the fire wall 15 or proxy server 16 to the user or to send the downloaded file by electronic mail to the user or whether to delete, step 664, the executable file with potentially malicious dependencies.

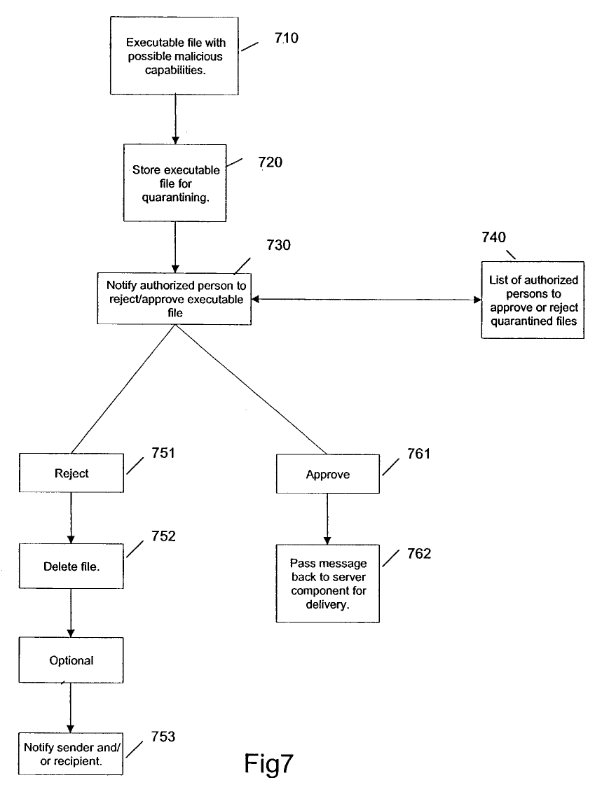

The use of the quarantine component 17 which interacts with the electronic mail analyser 11 & download analyser program 14 is illustrated in more detail in FIG. 7. When a file 710 with possible malicious dependencies is delivered to the quarantine component 17, the quarantine component 17 stores, step 720, the executable file; notifies, step 730, an authorised person selected by suitable criteria from a list 740 of authorised people and awaits further instructions. If the file is rejected, step 751, by the authorised person the quarantine component 17 deletes, step 752 the executable file. Optionally, the sender and/or intended recipient are notified, step 753, that the executable file has been deleted. If the authorised person approves, step 761, the executable file, the file is returned, step 762, to its queue for delivery to the intended recipient.

Although the method has been described with operator interaction, in an embodiment of the invention the disabling of the executable file may be carried out automatically when the probability that the executable file is malicious exceeds a predetermined value.

It will be understood that the invention provides a means intelligently to detect and analyse an executable file, and enables a system administrator to make an informed decision whether to “let in” the executable file. This makes a user, such as a company, relatively secure from malicious executable files, whilst still allowing in to the user's computer systems those non-malicious executable files that are required by the user.

I claim:

1. A system for detecting a potentially malicious executable file, the system comprising: trapping means for trapping an executable file and disassembling the executable file to provide an analysable file; analysing means in communication with the trapping means for analysing the analysable file to determine whether a program call is made by the executable file and whether the program call is potentially malicious; a database of potentially malicious program calls and details of the functions of the program calls and quarantining means in communication with the analysing means for quarantining the executable file, with details retrieved from the database of the function of the program call made by the potentially malicious executable file, if the program call is potentially malicious, for determination whether the potentially malicious executable file should be released from quarantine or deleted.

2. A system as claimed in claim 1, wherein the trapping means is adapted to trap an electronic mail message.

3. A system as claimed in claim 2, wherein the trapping means includes parsing means for parsing the message to determine whether the message has an attachment.

4. A system as claimed in claim 1, wherein the trapping means is adapted to receive a file to be downloaded to a computer system which file is trapped by at least one of a firewall and a proxy server.

5. A system as claimed in claim 4, wherein the trapping means includes parsing means for parsing the downloaded file to determine whether the file is executable.

6. A system as claimed in claim 1, wherein the analysing means is adapted for detecting a program call command.

7. A system as claimed in claim 1, wherein the analysing means is adapted for detecting a program making a system call.

8. A system as claimed in claim 1, wherein the analysing means is adapted for detecting a call to a dependent program.

9. A system as claimed in claim 1, wherein the analysing means is adapted for detecting a call to application extension code.

10. A system as claimed in claim 9, wherein the analysing means is adapted for detecting a call to at least one of dynamic link library (DLL) extension code and a COM object.

11. A system as claimed in claim 10, wherein the analysing means includes identification means for identifying the dynamic link library or COM object called and comparison means for comparing the identified dynamic link library executable code or COM object with a list of dynamic link library code or COM objects which are known to be potentially malicious.

12. A system as claimed in claim 1, wherein the analysing means includes means for determining whether there is a plurality of calls to dependent programs.

13. A system as claimed in claim 10, wherein the analysing means includes a database of characteristics of known potentially malicious dynamic link libraries and/or COM objects and means for interrogating the database for the characteristics of a dynamic link library and/or COM object to which a program call is made by the executable program.

14. A system as claimed in claim 1, wherein the quarantining means includes reporting means for providing to an administrator information on the executable file for the administrator to decide whether the executable file should be passed to an intended recipient or deleted.

15. A system as claimed in claim 1, wherein the quarantining means includes means for deleting the potentially malicious executable file.

16. A system as claimed in claim 1, wherein the quarantining means includes reporting means for informing at least one of a sender of the potentially malicious executable file and an intended recipient of the file that the file has been quarantined or deleted.

17. A method for detecting a potentially malicious executable file, the method comprising the steps of:
a) trapping an executable file;
b) disassembling the executable file to provide an analysable file;
c) analysing the analysable file to determine whether a program call is made by the executable file;
d) determining whether the program call is potentially malicious;
e) providing a database of potentially malicious program calls and their functions;
f) if the program call is potentially malicious, quarantining the executable file with the function of the potentially malicious program call retrieved from the database; and
g) determining at least partially from the function of the potentially malicious program call whether to delete or release from quarantine the potentially malicious executable file.

18. A method as claimed in claim 17, wherein the step of trapping the executable file comprises trapping an electronic mail message.

19. A method as claimed in claim 18, wherein the step of trapping the electronic mail message includes the step of parsing the message to determine whether the message has an attachment and trapping the message if the message has an attachment.

20. A method as claimed in claim 17, wherein trapping an executable file includes receiving a file to be downloaded to a computer system which file has been trapped by at least one of a firewall and a proxy server.

21. A method as claimed in claim 20, wherein the step of trapping the executable file includes parsing the file to be downloaded to determine whether the file is executable, and trapping the file if executable.

22. A method as claimed in claim 17, wherein the step of analysing the analysable file includes a step for detecting a program call command.

23. A method as claimed in claim 17, wherein the step of analysing the analysable file includes a step for detecting a program making a system call.

24. A method as claimed in claim 17, wherein the step of analysing the analysable file includes a step for detecting a call to a dependent program.

25. A method as claimed in claim 17, wherein the step of analysing the analysable file includes a step for detecting a call to application extension code.

26. A method as claimed in claim 25, wherein the step for detecting a call to application extension code includes a step for detecting a call to at least one of dynamic link library (DLL) executable code and a COM object.

27. A method as claimed in claim 26, wherein the step for detecting a call to dynamic link library executable code or a COM object includes identifying the dynamic link library or COM object called and the step of determining whether the system call is potentially malicious includes comparing the identified dynamic link library executable code or COM object with a list of dynamic link library code or COM objects to which calls are known to be potentially malicious.

28. A method as claimed in claim 17, wherein the step of determining whether the system call is potentially malicious includes determining whether there is a plurality of calls to dependent programs.

29. A method as claimed in claim 26, wherein the step of determining whether a system call is potentially malicious includes providing a database of characteristics of known potentially malicious dynamic link libraries and/or COM objects and interrogating the database for the characteristics of a dynamic link library and/or COM object to which a program call is made by the executable program.

30. A method as claimed in claim 29, wherein the step of quarantining the executable file includes providing to an administrator information on the executable file for the administrator to decide whether the executable file should be passed to an intended recipient or deleted.

31. A method as claimed in claim 30, wherein providing information on the executable file includes providing the characteristics of a dynamic link library or COM object to which a system call is made by the executable program.

32. A method as claimed in claim 17, wherein the step of quarantining the executable file includes a step for deleting the file.

33. A method as claimed in claim 17, wherein the step of quarantining the executable file includes informing at least one of a sender of the file and an intended recipient of the file that the file has been quarantined or deleted.
